(19) United States
(12) Patent Application Publication
(10) Pub. No.: US 2016/0339533 A1
(43) Pub. Date: Nov. 24, 2016

(54) ROBOTICALLY CONTROLLED GAS TUNGSTEN ARC WELDER AND METHOD FOR OPERATING THE SAME

(71) Applicant: ABB TECHNOLOGY AG, Zurich (CH)

(72) Inventors: MARK X. OXLADE, Oxford, MI (US); Chris E. Kuppe, Goodrich, MI (US); Magnus Lirell, Auburn Hills, MI (US)

(21) Appl. No.: 14/714,663

(22) Filed: May 18, 2015

(51) Int. Cl. B23K 9/12; B23K 9/095; B23K 9/16; B23K 9/29

(52) U.S. Cl. CPC B23K 9/123; B23K 9/295; B23K 9/0953; B23K 9/16

(57) ABSTRACT

A torch assembly used in an arc welder is disclosed. The assembly includes a head, an electrode extending from the head, and a non-linear delivery tube carrying a movable feed wire and extending from the head. A liner is maintained within the non-linear delivery tube wherein the liner receives the feed wire and facilitates movement of the feed wire. A method for controlling a welder and a related interface configuration are also disclosed.

### TECHNICAL FIELD

Generally, the present invention is directed to gas tungsten/metal arc welders and their operation. More particularly, the present application is directed to robotic control of the welder and the welding process. Specifically, the present invention is directed to the implementation of an Ethernet/Devicenet interface and modification of a welding torch to enable robotic operation of the welder.

### BACKGROUND ART

Gas tungsten/metal arc welding is currently a manual process. This process is difficult to master as the welder must maintain a short arc length between an electrode and a workpiece while simultaneously feeding a filler material, also known as a feed wire, into the weld area. Once an arc is struck, the welder moves a weld torch carrying the electrode in a small circle to create a welding pool. The size of the welding pool depends on the size of the electrode and the amount of current applied. While maintaining a constant separation between the electrode and work piece, the operator must manipulate the torch at a precise angle from vertical. The filler material is then added manually to the front end of the weld pool as needed.

In view of the complex nature of such a welding process, the utilization of robotics has not been actively pursued. A welding torch, which the welder handles in close proximity to a workpiece, includes an electrode and a wire delivery tube to place the feed wire near the arc. Current quasi S-shaped weld delivery tubes cannot accurately place the feed wire in the weld pool on a consistent basis. As a result, such a shape is not conducive for use in a robotic welding process. Moreover, no current system is available to coordinate operation of the gas tungsten weld torch with movement of the robotic arm. Therefore, there is a need in the art for an improved feed wire delivery system and to provide coordinated control of a robotic weld arm and the gas tungsten weld torch.

### SUMMARY OF THE INVENTION

In light of the foregoing, it is a first aspect of the present invention to provide a robotically controlled gas tungsten arc welder and method for operating the same.

It is another aspect of the present invention to provide a torch assembly used in an arc welder, that provides a head, an electrode extending from the head, a non-linear delivery tube carrying a movable feed wire and extending from the head, and a liner maintained within the non-linear delivery tube, wherein the liner receives the feed wire and facilitates movement of the feed wire.

It is yet another aspect of the present invention to provide a method for controlling a welder, by associating an arc welder with a robotic arm, programming the robotic arm to travel to a start position of a weld path, calling a predetermined weld parameter schedule from a power source, establishing an arc between an electrode of the arc welder and workpiece and setting outputs to initiate delivery of a feed wire from the power source and the weld parameter schedule, and simultaneously moving the robotic arm and oscillating the feed wire along the weld path.

It is still another aspect of the present invention to provide a robotic gas tungsten arc weld interface configuration, that provides a robotic arm, a torch assembly adapted to be mounted to the robotic arm, a wire feed unit supplying a feed wire to the torch assembly, a power source supplying power and control signals to the torch assembly, and a controller connected to and exchanging operational signals between the robotic arm, the wire feed unit and the power source so as to initiate an automatic welding sequence of at least two workpieces.

### BRIEF DESCRIPTION OF THE DRAWINGS

This and other features and advantages of the present invention will become better understood with regard to the following description, appended claims, and accompanying drawings wherein:

FIG. 1 is a schematic representation of a robotically controlled gas tungsten arc welder made according to the concepts of the present invention;

FIG. 2 is a schematic representation of a gas tungsten arc welder made in accordance with the concepts of the present invention;

FIG. 3 is an elevational view of the gas tungsten arc welder according to the concepts of the present invention;

FIG. 4 is a cross-sectional view of a delivery tube utilized in the gas tungsten arc welder according to the concepts of the present invention;

FIG. 5 is a system diagram illustrating an exchange of operational signals between components of the arc welder according to the concepts of the present invention; and

FIG. 6 is a flow chart showing operation of the robotically controlled gas tungsten arc welder.

### BEST MODE FOR CARRYING OUT THE INVENTION

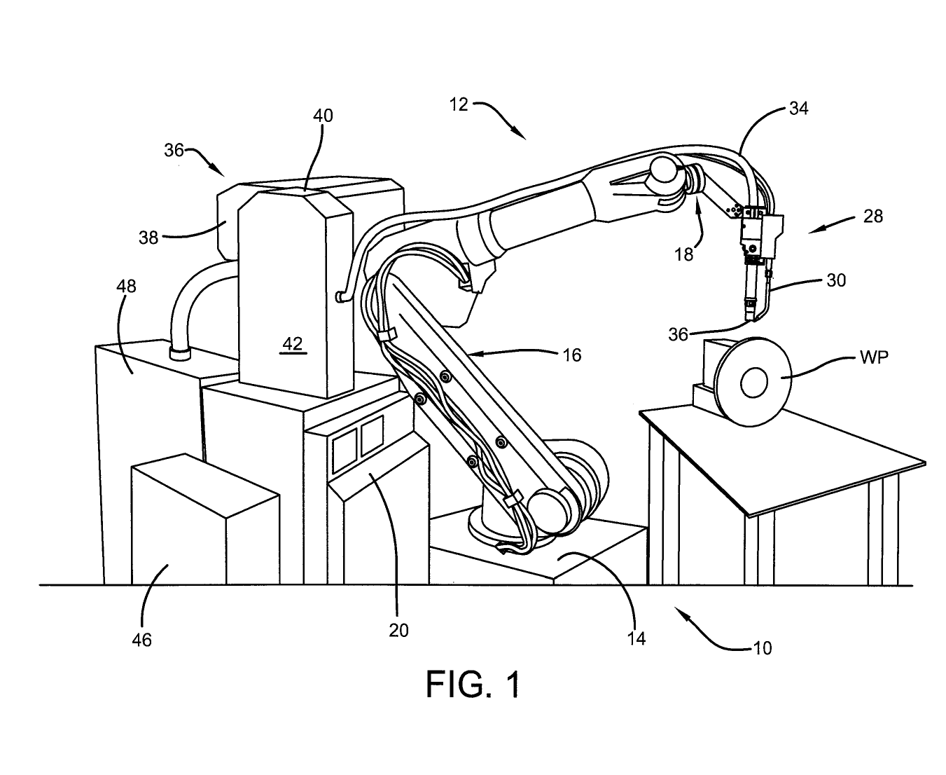

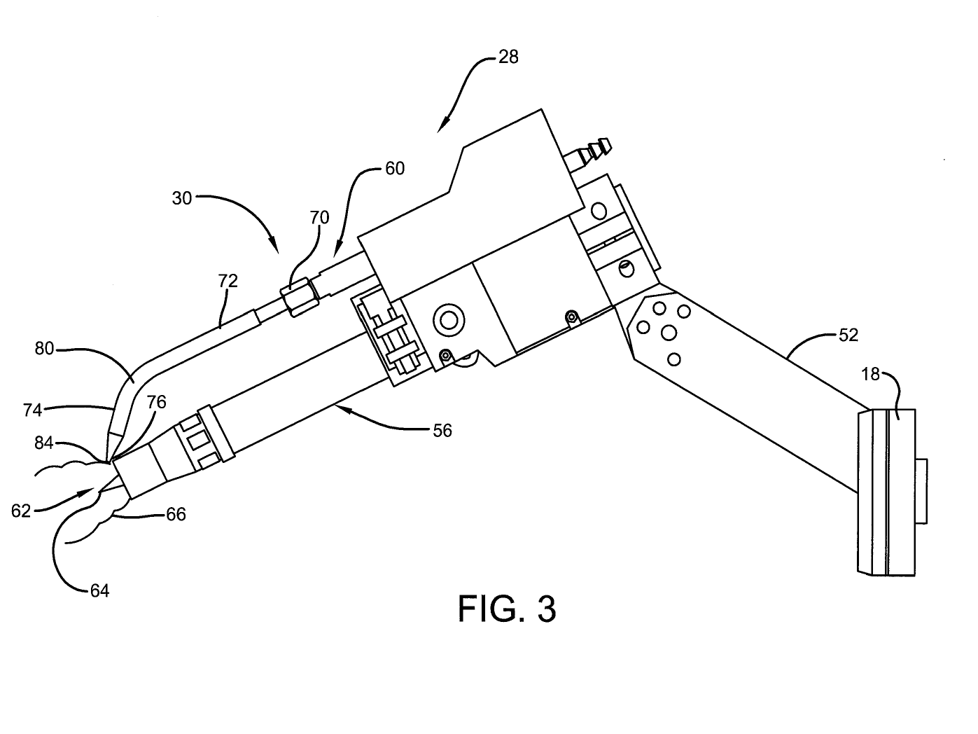

Referring now to the drawings and in particular to FIGS. 1-3, a robotically controlled gas tungsten arc welder is designated generally by the numeral 10. As will be described in detail, the integration of a robotic arm with a gas tungsten weld torch enables automation of the gas tungsten welding process. The disclosed device and related process allows for welding of joints that could not be achieved utilizing the traditional welding system due to fit-up limitations, wherein the disclosed system provides the desired speed and quality in excess of the previous processes.

The welder 10 includes a robotic arm 12 which moves about a workpiece designated as WP, wherein the workpiece includes at least two parts that are to be joined together. The arm 12 includes a base 14 which is connected to an articulated arm 16 which extends from the base wherein the arm moves with respect to the base in a precisely controlled and repeatable motion. A coupler 18 extends from an end of the articulated arm 16 opposite the base and is rotatably movable with respect to the arm 16. Movement of the robotic arm is controlled by a robotic arm controller 20 which implements various movements of the articulated arm and the coupler. In particular, the controller 20 provides input power, data instructions and the like to motors, hydraulics and the like so as to move the robotic arm in a desired manner. Skilled artisans will appreciate that the robotic arm controller 20 provides the necessary hardware, software and related programming so as to control operation of the robotic arm 12.

A gas tungsten arc welder, designated generally by the numeral 28, is associated with the robotic arm 12. The gas tungsten arc welder 28 includes a weld torch assembly 30 that is mounted to the coupler 18. A bundle conduit 34 may be associated with the torch assembly 30 and enables operation thereof. The conduit 34 supplies the gas material utilized in the welding process, a feed wire, and power and operational signals so as to control operation of the torch assembly. The opposite end of the conduit 34 may be maintained away from the robotic arm so as to collect the materials, power, feed wire and the like that are delivered to the torch assembly 30. In the robotic operation to be described, delivery and control of a feed wire to the torch assembly is important in obtaining an optimal weld between the two pieces of the workpiece WP.

A weld wire spool or carrier 36 may be maintained in close proximity to the robotic arm 12. The spool or carrier 36 carries a feed wire 38 (sometimes called a weld wire) that is delivered through the bundle conduit 34 to the torch assembly. The feed wire may be any metal or metal alloy material that is 1/16 inch in diameter or larger. The carrier 36 may be coupled to a wire feed unit 40 which delivers the feed wire 38 into the bundle conduit for delivery to the torch assembly. The wire feed unit 40 feeds the weld wire from the carrier at a constant rate while also oscillating the wire back and forth at a predetermined frequency. In some embodiments this frequency of oscillation may be between 10 to 20 Hz and in some embodiments about 17 Hz. In other embodiments the frequency of oscillation may be between 5 to 60 Hz. The wire feed unit 40 may move the feed wire in the forward or reverse directions.

A wire heater 42 may also be maintained in close proximity to the robotic arm 12. The wire heater 42 includes a transformer associated with the wire feed unit 40 and also provides a power cable that is received in the bundle conduit 34 for receipt by the torch assembly 30. The wire heater may preheat the feed wire in or near the torch assembly prior to the feed wire exiting the torch assembly so as to facilitate the welding process.

A power source 46 is connected to the wire feed unit 40 and the wire heater 42 so as to deliver the necessary power requirements to both components. A gas supply 48 may be maintained in close proximity to the robotic arm 12 and provides the inert gas that is delivered to the torch assembly 30 via the conduit 34.

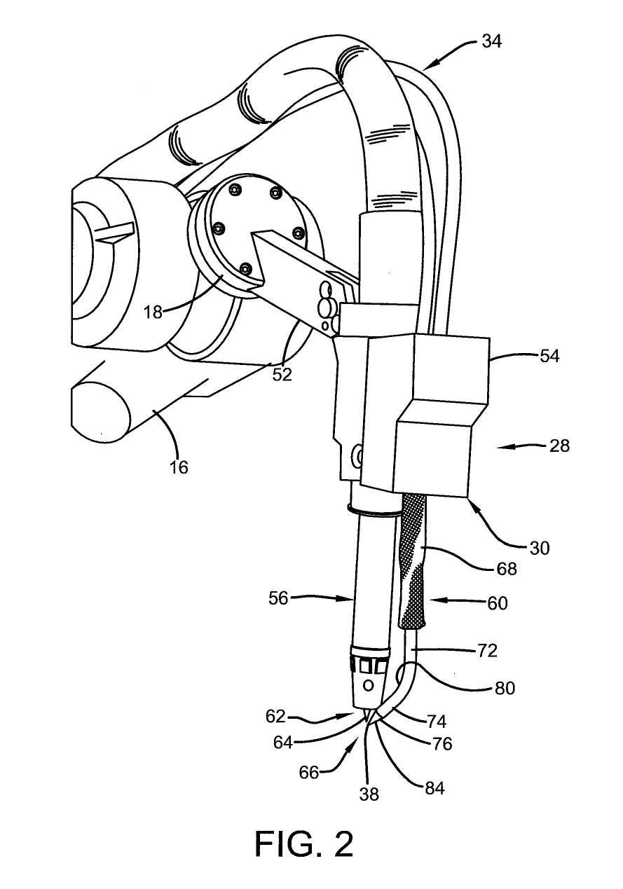

Referring now to FIGS. 2-4, it can be seen that the torch assembly 30 includes a coupler arm 52 that is connected to the coupler 18. As such, when the coupler arm rotates in either direction, the torch assembly 30 also rotates. A head 54 is mechanically connected to the coupler arm 52 and also receives the bundle conduit 34. The head 54 directs the various inputs such as the power, gas, feed wire and other components utilized by the torch assembly to its respective components, as will be discussed.

The torch assembly 30 includes a torch body 56 and a delivery tube 60. The torch body 56 includes a duct 62. A tungsten electrode 64 extends from the duct 62 and is connected to the power source 46 through the bundle conduit. An inert gas 66 is delivered from the gas supply 48 through the bundle conduit and into the duct 62 and around the electrode 64. As is well understood by those skilled in the art, the inert gas 66 is utilized to protect the welding area from atmospheric gases such as nitrogen and oxygen which can cause defects in the weld. The gas also transfers heat from the electrode to the workpiece and helps to start and maintain a stable arc during the welding process. The gas may be argon, helium, argon-helium mixtures or any other gas deemed appropriate for the particular weld being formed. The electrode 64 is typically made of tungsten or a tungsten alloy in view of its high melting temperature.

A delivery tube 60, which is of a non-linear configuration, receives the feed wire and a wire to heat the feed wire as it is delivered to the welding area. A heat protective sleeve 68 may cover a portion of the tube 60 that extends from the torch assembly 30. A coupling nut 70 allows for positional adjustment of the delivery tube 60 with respect to the torch body 56 and, in particular, the electrode 64. The delivery tube 60 includes a linear portion 72 which extends into an angular portion 74. The angular portion 74 extends from the linear portion 72 at an angle of anywhere between 30 to 60°. In specific embodiments the angle between the angular portion 74 and the linear portion 72 is about 50+/−2°. In most embodiments, the angle is about 50°. A radial transition 80 with a radius of curvature of the angular portion may be anywhere between 25 mm to 55 mm. In some embodiments the angle of curvature may be about 30 mm to 40 mm. In most embodiments, the angle of curvature is about 35 mm. There may also be a slight upward angular bend in the linear portion 72 just prior to transitioning to the angular portion 74. This slight angular bend may be anywhere from 1° to 10° in relation to the linear portion. Extending from the angular portion 74 is a tip portion 76 which is substantially conical in shape and allows for the feed wire to be positioned near the electrode. The tip portion 76 includes a tip opening 84 that allows the feed wire to extend outwardly toward the electrode.

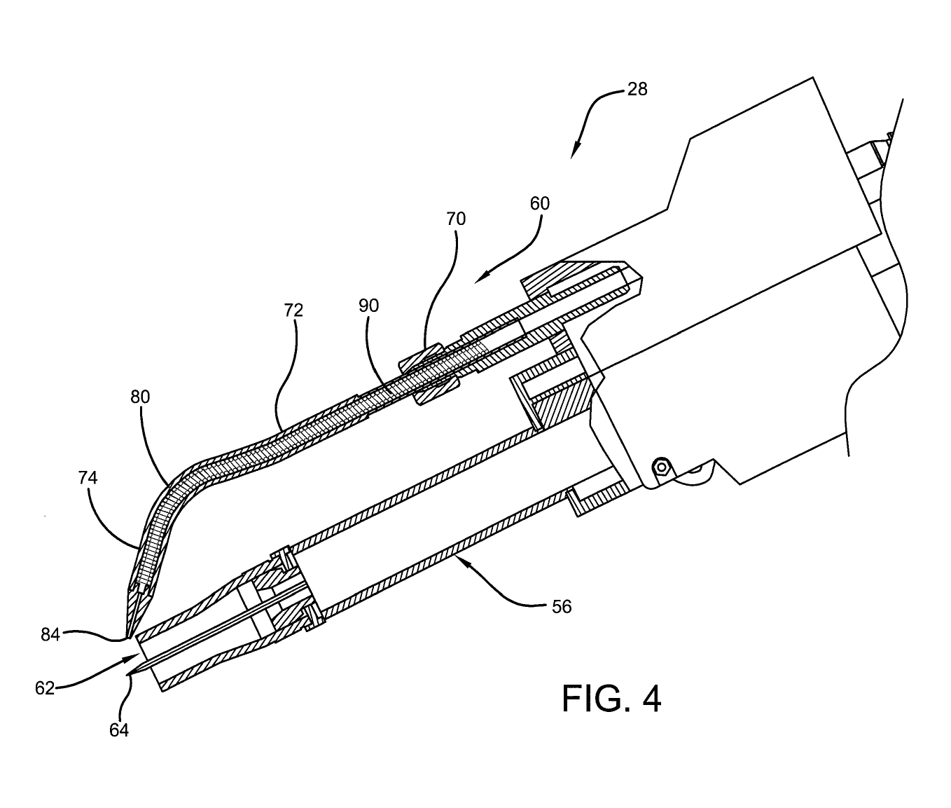

As best seen in FIG. 4, an inner liner 90 is received within the delivery tube 60 and extends from a distal end of the linear portion 72 through the angular portion 74 toward the tip portion 76. In the present embodiment the inner liner 90 may be made of a low friction material and may be of a helical construction. The inner liner 90 assists in delivering the feed wire to the tip and into the weld area with minimal interference and in a consistent manner. The liner material selected provides for a low friction internal passage of the feed wire and the desired heat dissipation. In some embodiments the low friction material is brass, but other materials which can withstand the heat of the welding process may also be employed. The liner may be of a tubular construction, but it is believed that a helical configuration, similar to a helical spring, provides minimal friction and a more reliable delivery of the feed wire.

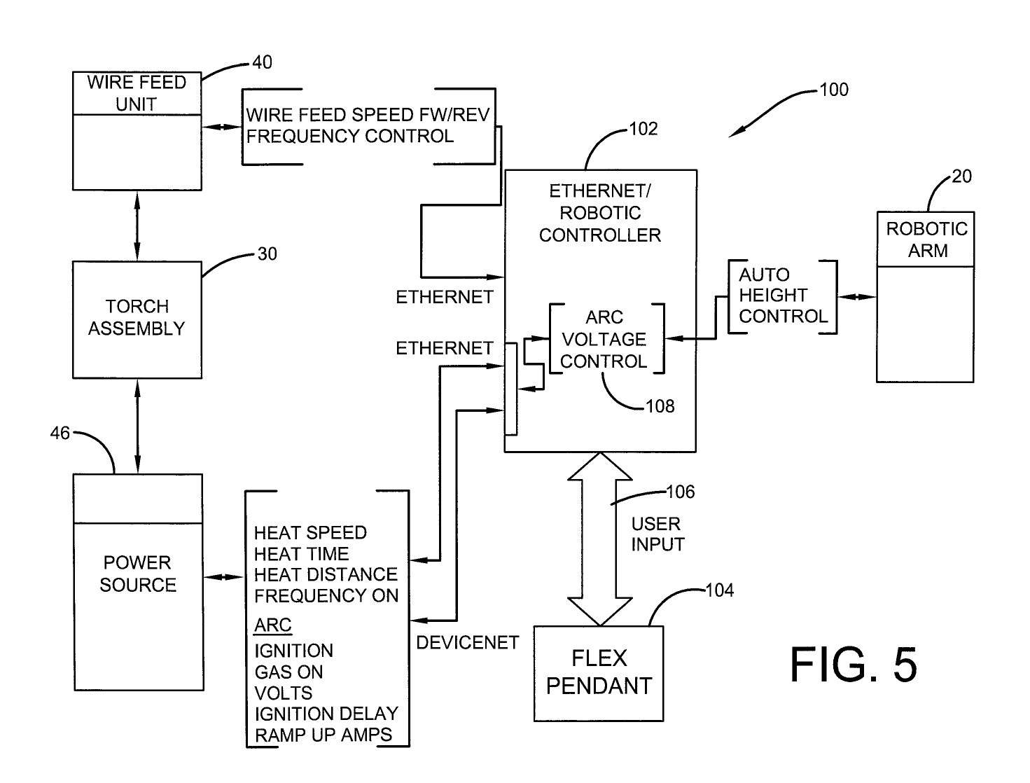

Referring now to FIG. 5, it can be seen that a schematic diagram of a control system 100 is provided which enables the coordination or interfacing of the robotic arm 12 with the gas tungsten arc welder 28. The control system 100 may employ an Ethernet™ communication protocol and/or a Devicenet™ protocol in order to transfer control and/or operation signals and otherwise coordinate operation between the various components of the welder 10. Other discrete operational signals between components may be employed. The control system 100 includes a robotic controller 102 which provides the necessary hardware, software and related components to implement operation of the welder 10. The controller 102 is typically maintained within the robotic arm controller 20 or within the same housing that maintains the robotic arm controller 20. In any event a flex pendant 104 is connected to the controller 102 and allows for user input for the various components connected to the controller. Among other things, the pendant allows a technician to input the desired motion of the robotic arm, all the operating parameters of the weld torch assembly, and coordination of when the weld torch operations are to take place during travel of the robotic arm in relation to the workpiece. Moreover, the controller 102 may provide status updates of the various components to the pendent 104. Connected to and in communication with the controller 102 is the robotic arm controller 20, the wire feed unit 40 and the power source 46. It will further be appreciated that the wire feed unit 40 and the power source 46 are in communication with the torch assembly. This communication allows for monitoring of the components within the torch assembly which can be relayed back to the controller and/or the robotic arm 20 to ensure the operating parameters are being followed.

An Arc Voltage Control 108, which may also be referred to as an Automatic/Adapative Height Control is maintained within the controller 102 and controls the distance or height between the tungsten electrode 64 and the workpiece WP. Skilled artisans will appreciate that the controller 102 provides instructions to the wire feed unit 40, such as the wire feed speed and the direction of the wire feed in either a forward or reverse direction. The wire feed unit also receives a frequency control signal so as to adjust oscillations of the feed wire as needed to obtain the desired weld. The wire feed unit 40 communicates or adjusts the actual physical parameters of the feed wire as the feed wire is delivered to the torch assembly 30.

The controller 102 provides Ethernet, Devicenet, and/or discrete signals to the power source 46 so as to control, initiate and/or cease a weld current, an arc on, a gas on and any other signal used by the power source to control and/or implement the welding process. The turning on and the oscillation of the wire feed unit 40 is also controlled by the controller 102. Initiation of the arc weld is controlled through the power source 46 utilizing such variables as the ignition on, the gas on (timing when the inert gas is delivered to the torch assembly), the application of volts to the feed wire and the electrode, the ignition delay and the ramp-up amp current to the electrode. The power source then provides these inputs to the torch assembly 30 for its operation.

The controller 102, through the Arc Voltage Control 108, also provides for control signals to the robotic arm 20 so as to control the position of the torch assembly with respect to the workpiece and how the robotic arm is to travel in relation to the workpiece as the weld progresses.

Once all of the parameters are programmed via the flex pendent 104 into the controller 102, the welding process may be initiated and controlled until completed.

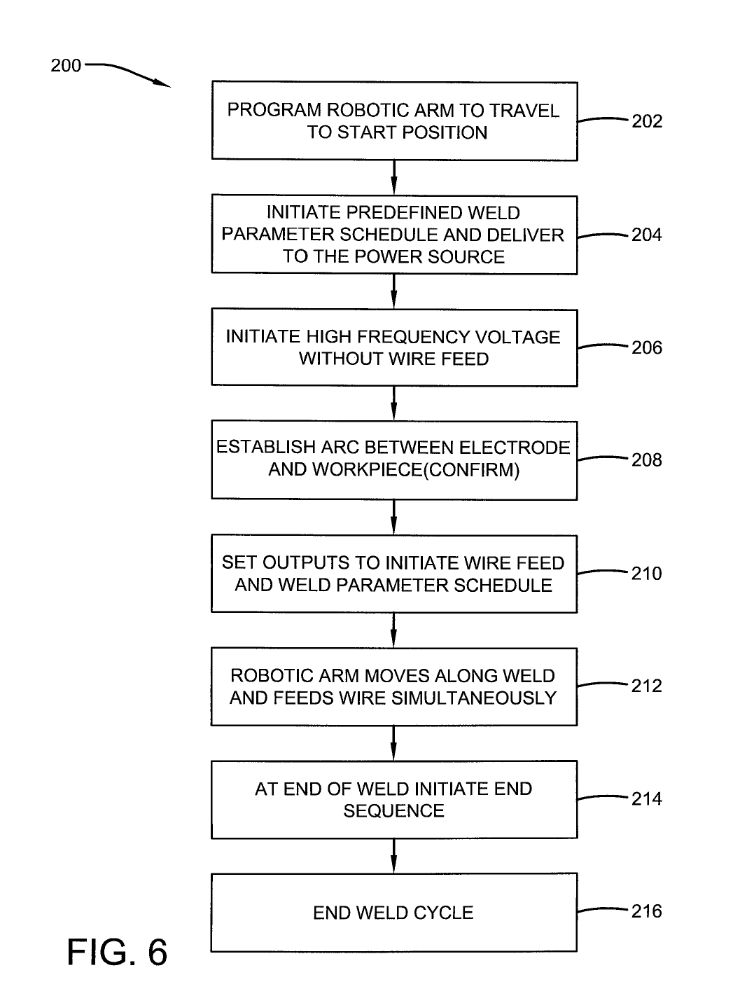

Referring now to FIG. 6, a methodology for operating the welder 10 is designated generally by the numeral 200. At step 202 the robotic arm is programmed to travel to a weld start position. Next, at step 204, the controller 102 initiates a predefined weld parameter schedule and delivers the schedule to the power source 46. The gas from gas supply 48 is delivered during the establishment of the arc between the electrode and the workpiece. Subsequently, a high frequency voltage is initiated and applied to the electrode without starting the wire feed supply at step 206. At step 208 an arc is established between the electrode and the workpiece.

Next, at step 210, the controller 102 sets the outputs to initiate the wire feed and a weld parameter schedule. This step begins the oscillation of the feed wire and provides the appropriate heating of the feed wire to start the welding process. Other outputs, such as delivery of the gas through the duct, are continued.

At step 212 the controller 102 initiates movement of the robotic arm 20 along a weld path and feeds the feed wire simultaneously at the predetermined rate of oscillation. During the weld sequence the Arc Voltage Control 108 maintains the workpiece to electrode height. As the robotic arm reaches the end of the weld path along the workpiece, an end of weld initiate weld schedule, which ramps down the various applications of the voltage and current to the feed wire and the electrode, is initiated and completed. Once completed, the weld cycle ends at step 216 and the torch assembly is moved away from the workpiece, whereupon the completed workpiece is moved and a new workpiece is positioned into place to begin the next welding operation.

The disclosed torch assembly, the interface configuration and the methodology is advantageous for a number of reasons. The integrated interface and unique filler wire delivery system enables the process to be implemented robotically. The combination of the robot torch assembly and associated software allows the process to produce welds of higher quality and that are completed faster compared to manual gas tungsten arc welding and conventional robotic gas tungsten arc welding. The system can operate at comparable deposition rate with higher cleanliness than previously provided. It is believed that such a system allows for less heating and more forgiving wetting parameters which result in less product rework, less distortion, faster throughput and significantly improved aesthetics. The delivery tube is also advantageous in that it allows for low-friction delivery of the feed wire so as to ensure a consistent weld. The delivery tube provides for an inner liner that along with the angular and radial configuration of the delivery tube reduces friction through the delivery tube and further enhances the feed wire delivery process.

Thus, it can be seen that the objects of the invention have been satisfied by the structure and its method for use presented above. While in accordance with the Patent Statutes, only the best mode and preferred embodiment has been presented and described in detail, it is to be understood that the invention is not limited thereto or thereby. Accordingly, for an appreciation of the true scope and breadth of the invention, reference should be made to the following claims.

What is claimed is:

1. A torch assembly used in an arc welder, comprising:
a head;
an electrode extending from said head;
a non-linear delivery tube carrying a movable feed wire and extending from said head; and
a liner maintained within said non-linear delivery tube, said liner receiving said feed wire and facilitating movement of said feed wire.

2. The torch assembly according to claim 1, wherein said non-linear delivery tube comprises:
a linear portion extending from said head;
an angular portion extending from said linear portion; and
a tip portion having an opening and extending from said angular portion and having an angle of anywhere between 30° and 60°.

3. The torch assembly according to claim 2, wherein said angular portion and said linear portion have a radial transition therebetween of 25 to 50 mm.

4. The torch assembly according to claim 1, wherein said liner is made from brass.

5. The torch assembly according to claim 1, wherein said liner is made from a helically wound brass material.

6. A method for controlling a welder, comprising:
associating an arc welder with a robotic arm;
programming said robotic arm to travel to a start position of a weld path;
calling a predetermined weld parameter schedule from a power source;
establishing an arc between an electrode of said arc welder and workpiece and setting outputs to initiate delivery of a feed wire from said power source and said weld parameter schedule; and
simultaneously moving said robotic arm and oscillating said feed wire along said weld path.

7. The method according to claim 6, further comprising:
designating said predetermined weld parameter schedule for gas tungsten arc welding.

8. The method according to claim 6, further comprising:
initiating a ramp down procedure at an end position of said weld path.

9. The method according to claim 6, further comprising:
utilizing an input device to program both said robotic arm and said predetermined weld parameter schedule.

10. The method according to claim 6, further comprising:
providing said robotic arm with automated height control.

11. A robotic gas tungsten arc weld interface configuration, comprising:
a robotic arm;
a torch assembly adapted to be mounted to said robotic arm;
a wire feed unit supplying a feed wire to said torch assembly;
a power source supplying power and control signals to said torch assembly; and
a controller connected to and exchanging operational signals between said robotic arm, said wire feed unit and said power source so as to initiate an automatic welding sequence of at least two workpieces.

12. The interface configuration according to claim 11, wherein said robotic arm and said controller exchange an auto height control signal so as to maintain a predetermined distance between an electrode carried by said torch assembly and the at least two workpieces.

13. The interface configuration according to claim 11, wherein said wire feed unit and said controller exchange at least wire feed speed and wire frequency control signals so as to deliver a feed wire from said wire feed unit to said torch assembly.

14. The interface configuration according to claim 11, wherein said power source and said controller exchange at least wire heat and arc signals so as to heat a feed wire delivered from said wire feed unit to said torch assembly and initiate an arc between an electrode maintained by said torch assembly and the at least two workpieces.

15. The interface configuration according to claim 11, wherein said robotic arm and said controller exchange an auto height control signal so as to maintain a predetermined distance between an electrode carried by said torch assembly and the at least two workpieces, wherein said wire feed unit and said controller exchange at least wire feed speed and wire frequency control signals so as to deliver a feed wire from said wire feed unit to said torch assembly, and wherein said power source and said controller exchange at least wire heat and arc signals so as to heat a feed wire delivered from said wire feed unit to said torch assembly and initiate an arc between an electrode maintained by said torch assembly and the at least two workpieces.

16. The interface configuration according to claim 15, further comprising
a pendant connected to said controller, wherein a user input allows adjustment of said auto height control signal, said wire feed speed and wire frequency control signals, and said wire heat and arc signals.
